(19) United States
(12) Patent Application Publication
(10) Pub. No.: US 2006/0277547 A1
(43) Pub. Date: Dec. 7, 2006

(54) Task management system

(76) Inventor: Mutsumi Abe, Tokyo (JP)

Correspondence Address: KENYON & KENYON LLP, 1500 K STREET N.W., SUITE 700, WASHINGTON, DC, 20005, US

(21) Appl. No.: 10/579,339

(22) PCT Filed: Oct. 22, 2004
(86) PCT No.: PCT/JP04/16072

§ 371 Date: May 15, 2006

(30) Foreign Application Priority Data
Nov. 18, 2003 (JP) 2003-388356

(51) Int. Cl. G06F 9/46

(52) U.S. Cl. 718/104

(57) ABSTRACT

A judgment unit judges whether or not an execution of a registration target task gaining an access to a specified resource can be completed before an elapse of deadline time thereof even if an execution start timing of the registration target task is delayed when registering the task. A registration unit registers, as an execution target task, the registration target task judged such that the execution thereof can be completed before the elapse of the deadline time. A control unit halts a resource assignment to a task trying to access the specified resource afterward till a resource assignment to a task having earlier accessed to the specified resource is completed among the tasks registered as the execution target tasks when switching over the task.

### TECHNICAL FIELD

The present invention relates to a technology for preventing inconvenience caused by a conflict between accesses to a resource requiring exclusive control such as a variety of input/output processes between executable tasks.

### BACKGROUND ARTS

There has hitherto been known a technology (refer to, e.g., Patent Document 1) for executing a task in a way that switches over the task in accordance with priorities, etc. of the tasks.

(Patent Document 1) Japanese Patent Application Laid-Open Publication No.2001-236236

If there occurs the conflict between the accesses to the resource requiring the exclusive control such as the variety of input/output processes between the executable tasks, however, when the task is switched over simply as done in the prior art, a proper process can not be executed because of the occurrence of the conflict. Further, when the exclusive control is simply effected upon the resource with the access conflict occurred in order to avoid such a situation, an unexpected time delay occurs, and there might be a possibility that a set deadline can not be kept.

### DISCLOSURE OF THE INVENTION

It is an object of the present invention to provide a technology for assuring a resource assignment to a task having accessed earlier and assuring also a deadline of the resource assignment to each task even in a case where there occurs a conflict between accesses to a resource requiring exclusive control such as a variety of input/output processes between executable tasks.

The present invention, which was devised to solve the problems described above, is a task management system comprising a judgment unit for judging whether or not an execution of a registration target task gaining an access to a specified resource can be completed before an elapse of deadline time thereof even if an execution start timing of the registration target task is delayed when registering the task, a registration unit for registering, as an execution target task, the registration target task judged such that the execution thereof can be completed before the elapse of the deadline time, and a control unit for halting a resource assignment to a task trying to access the specified resource afterward till a resource assignment to a task having earlier accessed to the specified resource is completed among the tasks registered as the execution target tasks when switching over the task.

According to the present invention, it is judged whether or not the execution of the registration target task accessing the specified resource (e.g., the resource requiring exclusive control such as a variety of input/output processes between executable tasks) can be completed before the elapse of the deadline time thereof even if the execution start timing of the registration target task is delayed when registering the task. The registration target task judged such that the execution thereof can be completed before the elapse of the deadline time, is registered as the execution target task. Then, when switching over the task, the resource assignment to the task trying to access the specified resource afterward is halted till the resource assignment to the task having earlier accessed to the specified resource is completed among the tasks registered as the execution target tasks. Accordingly, even if there occurs the conflict between the accesses to the specified resource, it is possible to assure the resource assignment to the task having accessed earlier and assure also the deadline of the resource assignment to each task.

Further, the present invention can also be specified as follows.

A task management system comprises a judgment unit for judging whether or not an execution of a registration target task gaining an access to a specified resource can be completed before an elapse of deadline time thereof even if an execution start timing of the registration target task is delayed when registering the task, a registration unit for registering, as an execution target task, the registration target task judged such that the execution thereof can be completed before the elapse of the deadline time, an execution unit for preferentially executing a task having a shorter period of deadline time among the tasks registered as the execution target tasks, and a control unit for halting a resource assignment to a task trying to access the specified resource afterward till a resource assignment to a task having earlier accessed to the specified resource is completed among the tasks registered as the execution target tasks when switching over the task.

Still further, the present invention can be specified by way of the invention of a method as follows.

A task management method comprises a step of judging whether or not an execution of a registration target task gaining an access to a specified resource can be completed before an elapse of deadline time thereof even if an execution start timing of the registration target task is delayed when registering the task, a step of registering, as an execution target task, the registration target task judged such that the execution thereof can be completed before the elapse of the deadline time, and a step of halting a resource assignment to a task trying to access the specified resource afterward till a resource assignment to a task having earlier accessed to the specified resource is completed among the tasks registered as the execution target tasks when switching over the task.

A task management method comprises a step of judging whether or not an execution of a registration target task gaining an access to a specified resource can be completed before an elapse of deadline time thereof even if an execution start timing of the registration target task is delayed when registering the task, a step of for registering, as an execution target task, the registration target task judged such that the execution thereof can be completed before the elapse of the deadline time, a step of preferentially executing a task having a shorter period of deadline time among the tasks registered as the execution target tasks, and a step of halting a resource assignment to a task trying to access the specified resource afterward till a resource assignment to a task having earlier accessed to the specified resource is completed among the tasks registered as the execution target tasks when switching over the task.

Yet further, the present invention can be specified by way of the invention of a program as follows.

A program serves to make a computer execute a step of judging whether or not an execution of a registration target task gaining an access to a specified resource can be completed before an elapse of deadline time thereof even if an execution start timing of the registration target task is delayed when registering the task, a step of registering, as an execution target task, the registration target task judged such that the execution thereof can be completed before the elapse of the deadline time, and a step of halting a resource assignment to a task trying to access the specified resource afterward till a resource assignment to a task having earlier accessed to the specified resource is completed among the tasks registered as the execution target tasks when switching over the task.

A program serves to make a computer execute a step of judging whether or not an execution of a registration target task gaining an access to a specified resource can be completed before an elapse of deadline time thereof even if an execution start timing of the registration target task is delayed when registering the task, a step of for registering, as an execution target task, the registration target task judged such that the execution thereof can be completed before the elapse of the deadline time, a step of preferentially executing a task having a shorter period of deadline time among the tasks registered as the execution target tasks, and a step of halting a resource assignment to a task trying to access the specified resource afterward till a resource assignment to a task having earlier accessed to the specified resource is completed among the tasks registered as the execution target tasks when switching over the task.

Moreover, the present invention can be also specified as a readable-by-computer storage medium stored with the programs described above.

### BRIEF DESCRIPTION OF THE DRAWINGS

FIG. 1 is an explanatory diagram of an outline of a system architecture of a task management system in one embodiment of the present invention;

FIG. 2 is an explanatory flowchart of an operation when registering a task in the task management system;

FIG. 3 is an explanatory diagram showing a concept of judgment about task registrability;

FIG. 4 is an explanatory diagram showing the concept of the judgment about the task registrability; and

FIG. 5 is an explanatory flowchart of an operation when switching over the task in the task management system.

### BEST MODE FOR CARRYING OUT THE INVENTION

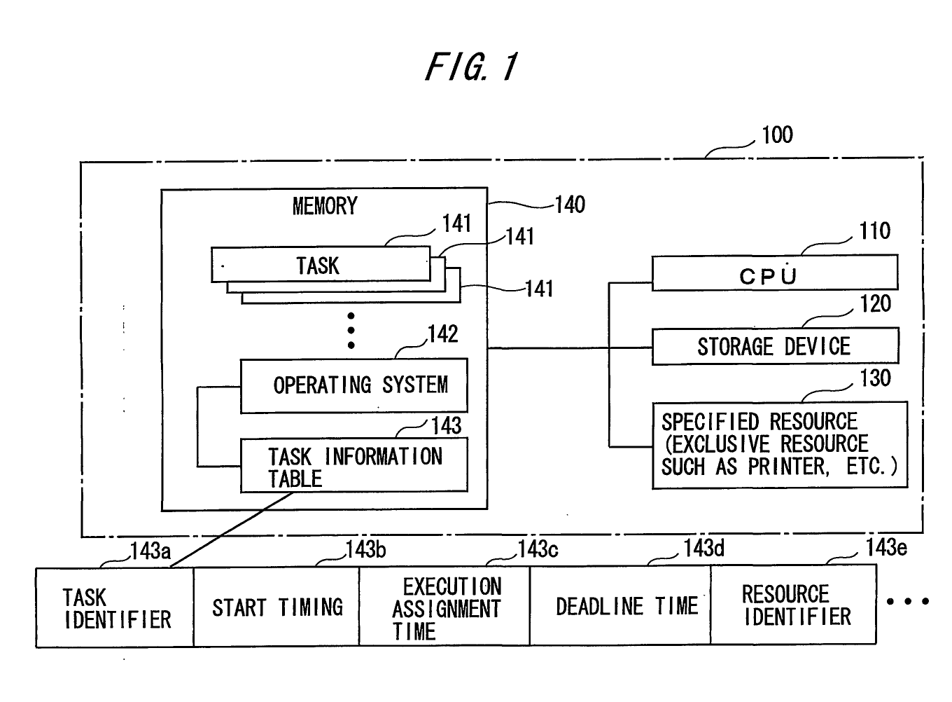

A task management system will hereinafter be described by way of one embodiment of the present invention with reference to the drawings. FIG. 1 is an explanatory diagram of an outline of a system architecture of the task management system in the present embodiment.

(Environment of System)

The task management system in the present embodiment is actualized by a general type of information processing device such as a PDA (Personal Digital Assistant), a personal computer and so on. As shown in FIG. 1, an information processing device 100 includes a CPU 110, a storage device 120 such as a hard disc device, etc., specified resources 130, a memory 140 and so forth. The information processing device 100 may further include an input device (e.g., a key set) for inputting various pieces of information and commands, an image display device (e.g., a liquid crystal display) for displaying a processing result, etc., a voice output device (e.g., a loudspeaker), and so on (none of these devices are shown).

(Task and Operating System)

A task 141, which is generally called a process or a thread, is a generic name of an execution unit of a program. The task 141 may be generated when in a task registration and may also be previously generated (pooled) as done in the preceding application by the present applicant. The task 141 is, for example, a QoS (Quality of Service) task defined as a variable task capable of controlling a required quantity of resources.

The operating system (OS) 142 is, for instance, a realtime OS having a function (as a scheduler) of scheduling the respective tasks 141 by a DM (Deadline Monotonic) method. Among the executable tasks 141 (corresponding to execution target tasks according to the present invention) at respective scheduling timings, the task 141 exhibiting the shortest period of deadline time is set as an active task. Each of the tasks 141 is managed based on a task information table 143. The task information table 143 is a table for managing pieces of information about the individual tasks. The task information table 143 is registered with pieces of the information about the tasks 141, such as a task identifier 143a, a start timing 143b, execution assignment time 143c, deadline time 143d and a resource identifier 143e.

The task identifier 143a serves to identify each task 141. The start timing 143b is a period of time (period) till a next execution start timing since an execution start timing of each task 141. When a certain task 141 is executed, it does not happen that this task 141 is executed afresh during this period. The execution assignment time 143c is defined as a resource quantity (which is herein a period of usage time of the CPU 110) assigned to each of the tasks 141. It should be noted that the resource is not necessarily assigned continuously for a period of assignment time throughout to the task 141 that has been once assigned the resource. A time assignment may be effected separately any number of times. Further, if preempted by a different task 141 having a higher priority than a certain task 141, processing of this task 141 is interrupted.

If the alignment time elapses within a certain period of time, nothing affects the system. This period of time is the deadline time 143d. In the present embodiment, a higher priority is given to the task 141 exhibiting a short period of deadline time 143d than that of the task 141 showing a long period of deadline time 143d. The task 141 having the short deadline time 143d (i.e., the task 141 given the high priority) is set as an active task. The resource identifier 143e serves to identify a resource (corresponding to a specified source according to the present invention) that is used by each of the tasks 141 and needs exclusive controlling. This category of resources may be exemplified such as a printer, a display and so on. Those resources may be built in the information processing device 100 or may be externally provided. Note that each task 141 may be assigned one single resource identifier 143e or may also be assigned a plurality of resource identifiers 143e.

Predetermined programs such as API (Application Program Interface), etc. for providing the schedule function described above and other various functions that will be described later on, are read by the aforementioned information processing device 100 and installed into the operating system, thereby actualizing these functions. Note that the operating system 142 and the predetermined programs, etc. are pre-installed into the storage device 120 or the like, and are properly read into the memory 140 and executed as the necessity arises (see FIG. 1).

(Operation at Task Registration)

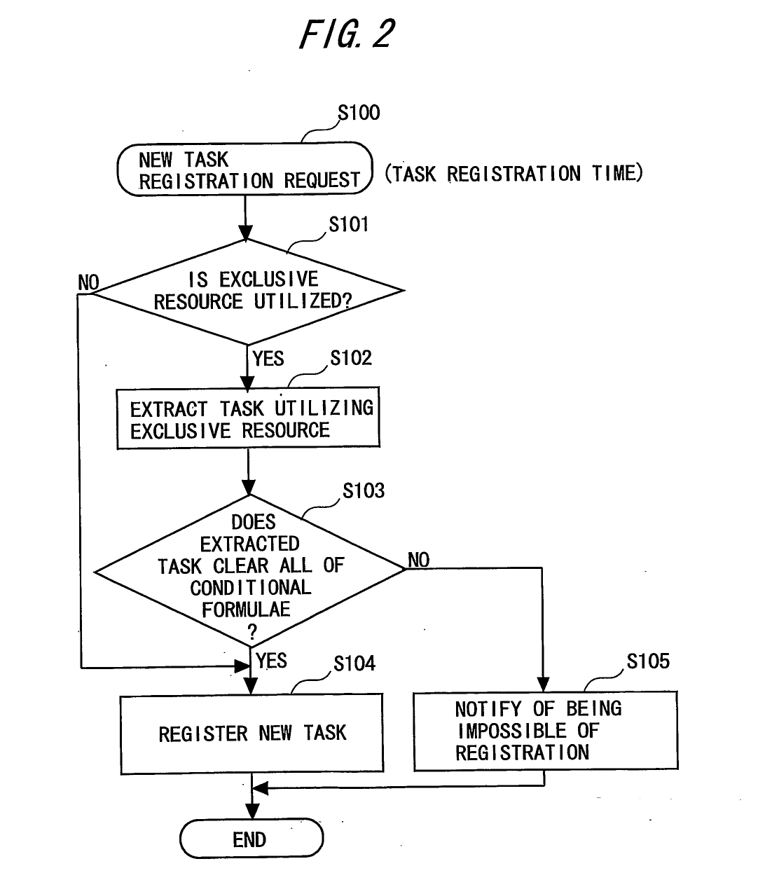

Next, an operation of the task management system having the architecture described above will be explained with reference to the drawings. To start with, processes when registering the task will be described. FIG. 2 is an explanatory flowchart of the processes when registering the task.

The operating system 142, etc., is read and executed by the information processing device 100, thereby actualizing the following processes. When a new task registration request is given from the operating system 142, a predetermined application, etc. (S100), it is judged whether or not the task 141 requested to be registered (which corresponds to a registration target task according to the present invention and will therefore hereinafter also be called the registration target task) utilizes an exclusive resource 130 (corresponding to a specified resource according to the present invention) (S101). For instance, the resource identifier 143e associated with this registration target task 141 is collated with a specified identifier (an identifier of, e.g., a printer, a display or the like, which are not shown). As a result, if coincident with each other, it is judged that this registration target task 141 utilizes the exclusive resource 130 (S101: Yes). Note that whereas if the registration target task 141 is judged not to utilize the exclusive resource 130 (S101: No), this registration target task 141 is registered as a new task (S104). In this case, a judgment (S102 and S103) as to a possibility of the task registration, which will be explained later on, is not made. The reason for this is that even when registering the registration target task 141, a conflict of accessing the exclusive resource 130 does not occur.

While on the other hand, it is judged that the registration target task 141 utilizes the exclusive resource 130 (S101: Yes), the judgment about the possibility of the task registration is made (S102 and S103). This is because of assuring the deadline time 143d of the registration target task 141. Namely, when this task 141 is registered, the conflict of the access to the exclusive resource 130 occurs, and, since there might be a possibility in which the deadline time 143d is not kept, that is intended to be a judgment as to whether or not an execution of the registration target task 14 gaining an access to the exclusive resource 130 can be completed before an elapse of the deadline time 143d thereof even if an execution start timing of this task 141 is delayed at the time of registering the task (previously) (which corresponds to a judgment unit according to the present invention). When judging that the execution can not be completed before the elapse of the deadline time 143d (S103: No), the registration target task 141 is not registered, and registration unpermitted notification is given (S105).

While on the other hand, when judging that the execution can be completed before the elapse of the deadline time 143d (S103: Yes), the registration target task 141 is registered as an execution target task (which corresponds to a registration unit according to the present invention). The task information table 143 is registered with, for example, the task identifier 143a of that registration target task 141, the resource identifier 143e of the resource utilized by the registration target task 141, and so on.

(Concept of Judgment about Possibility of Task Registration)

As described above, the judgment of the possibility of the task registration is a process for assuring the deadline time 143d. To be specific, it is judged whether or not the execution of the registration target task 141 can be completed before the elapse of the deadline time 143d even if the execution start timing of the registration target task 141 having the access to the exclusive resource 130 is delayed when registering the task.

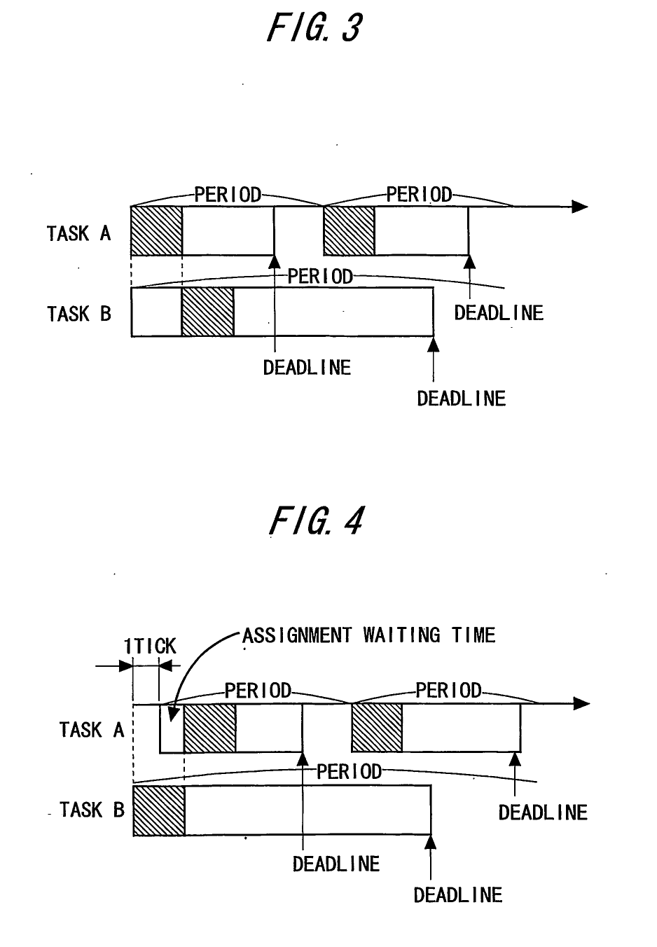

A concept of this judgment will be elucidated with reference to FIGS. 3 and 4. FIGS. 3 and 4 exemplify two tasks, i.e., a task A and a task B executed by the operating system 142. The task A and the task B utilize the resource (e.g., the same resource) that is in an exclusive relationship. Further, the deadline time of the task A is shorter than the deadline time of the task B. Namely, the task A is given a higher priority than that of the task B.

FIG. 3 shows a state where the task A becomes executable earlier (or both of the task A and the task B get executable simultaneously). In this case, the task B is kept waiting till an end of the assignment time 143c of the task A. This is ascribed to the task A being given the higher priority than that of the task B. The conventional scheduling can work in response to this case.

FIG. 4 shows a state in which the task B becomes executable earlier. In this case, the task A is kept waiting till the end of the assignment time 143c of the task B. Namely, as for the tasks A and B accessing the exclusive resource 130, even if the access conflict occurs when switching over the task, an assignment to the task A trying to access later on is delayed till the resource assignment to the task B having accessed earlier is completed. If simply delayed, however, there exists a possibility that the deadline time for the resource assignment to each of the tasks can not be assured. Such being the case, even if the assignment (e.g., the execution assignment time 143c) to the task A trying to access later on is delayed in a way that assures the resource assignment (e.g., the execution assignment time 143c) to the task B having accessed earlier, it is necessary to assure the deadline time 143d of the resource assignment to each of the tasks. Therefore, the judgment about the possibility of the task registration (which is alternatively termed a restriction check or reservation judgment) is made (S102 and S103). Namely, it is judged whether or not the resource assignments to both of the tasks meet the respective periods of deadline time 143d of the tasks. Specifically, it is judged whether or not the execution of the registration target task accessing the exclusive resource 130 can be completed before the elapse of the deadline time 143d even if the execution start timing of the registration target task is delayed when registering the task. As a result of this judgment, the registration target task, of which the execution is judged to be executable (deadline assurance) before the elapse of the deadline time 143d thereof, is registered as the execution target task (the new task).

Thus, the judgment as to the possibility of the task registration is made before registering the task (previously), and hence, even if the access conflict occurs, it follows that the respective periods of deadline time 143d of the resource assignments to the tasks are also assured.

(Details of Judgment of Possibility of Task Registration)

Next, the judgment about the possibility of the task registration will be described in detail referring back to FIG. 2.

When the registration target task 141 is judged to utilize the exclusive resource 130 (S101: Yes), the task utilizing the same resource as this exclusive resource 130 is extracted (S102). For instance, the task 141 with which to associate the resource identifier 143e coincident with the resource identifier 143e associated with the task identifier 143a of the registration target task 141, is extracted, with the above resource identifier 143e serving as a key, from the task information table 143. Next, it is judged whether or not the-thus extracted task 141 clears all of conditional formulae (S103). This is, as described above, the process for judging the possibility of the task registration. Specific examples of the conditional formulae will be explained.

To begin with, a case where there are the tasks A, B, C, D and E in the sequence of the priority from the highest, and the task C and the task D are in the exclusive relationship, is considered by way of a first example. In this case, it is judged whether next two conditions are met or not. If these conditions are met, the registration target task (e.g., the task C) is judged registerable (possible of its task registration) (S103: Yes).

(Condition 1) The tasks A, B, C, D and E shall be schedulable from the judgment by the conventional DM method.

(Condition 2) D(c)≧E(c)+(E(d)−1 Tick time)

Note that T(i) represents a period of an (i)th task, D(i) denotes deadline time of the (i)th task, C(i) designates assignment time of the (i)th task, E(i) indicates required time of the (i)th task, N shows a task number of the task of which the required time is obtained, and ┌A┐ represents round-up of an arithmetic result of A. Further, the equations are given as follows. E(c)=C(c)+C(a)×(┌E(c)/T(a)┐)+C(b)×(┌E(c)/T(b)┐), E(d)=C(d)+C(a)×(┌E(d)/T(a)┐)+C(b)×(┌E(d)/T(b)┐).

A significance of the condition 2 will be briefly explained with reference to FIG. 4. In FIG. 4, a case where the task A is kept waiting longest is that the task A becomes executable at a timing of next scheduling (when the scheduler operates) after starting the assignment to the task B. A timing interval at which the scheduling is conducted is a fixed interval such as “1 Tick”, and hence this value (1 Tick) is given in the condition 2.

More specifically, a premise of the registrability judgment based on the DM (Deadline Monotonic) method is that the preemption is conducted by the task having a shorter deadline. If the execution of the task assuming the exclusive relationship is underway, however, an access restricted task is unable to preempt even when having the shorter deadline. Namely, even when the access restricted task reaches an execution starting point, this access restricted task might be kept waiting for a period of time equivalent to [the end of execution of the task having a longer deadline and assuming the exclusive relationship minus (−) 1 Tick]. Further, at this time, it is necessary to consider also the execution time of the task assuming the exclusive relationship and having the short deadline.

Accordingly, if total time of [the execution time of the task assuming one exclusive relationship and exhibiting a low priority minus (−) 1]+[the execution time of the task assuming all the exclusive relationships and exhibiting a high priority]+[the execution time of the self-task] falls within the deadline of the self-task, it is considered schedulable. Note that each task could be preempted by the task assuming none of the exclusive relationships and having a shorter deadline, and therefore the execution time of the task must takes this into consideration. This category of time is herein defined as a required period of time of the task. It is to be noted that the required time (E(n)) of the task is derived from the aforementioned formula.

Next, a case where there are the tasks A, B, C, D, E and F in the sequence of the priority from the highest, and the exclusive relationship exists between the tasks A and C and between the tasks B, D and E, is considered by way of a second example. In this case, it is judged whether the following five conditions are met or not. If these conditions are met, the registration target task (e.g., the task E) is judged registerable (S103: Yes).

(Condition 1) The tasks A, B, C, D, E and F shall be schedulable from the judgment by the conventional DM method.
(Condition 2) D(a)≧E(a)+(E(c)−1 Tick time)
(Condition 3) D(b)≧E(b)+(E(d)−1 Tick time)
(Condition 4) D(b)≧E(b)+(E(e)−1 Tick time)
(Condition 5) D(d)≧E(d)+(E(b)+(E(e)−1 Tick time)

Note that the equations are given as follows. E(a)=C(a), E(b)=C(b)+C(a)×(┌E(b)/T(a)┐), E(c)=C(c)+C(b)×(┌E(c)/T(b)┐), E(d)=C(d)+C(a)×(┌E(d)/T(a)┐)+C(c)×(┌E(d)/T(c)┐), E(e)=C(e)+C(a)×(┌E(e)/T(a)┐)+C(c)×(┌E(e)/T(c)┐).

It is judged whether or not the task 141 extracted in S102 clears all the conditional formulae (the conditional formulae as given in the first example or the second example). Then, when judging that each task 141 clears all the conditional formulae (S101: No), this registration target task 141 is registered as a new task (S104).

(Operation at Switchover of Task)

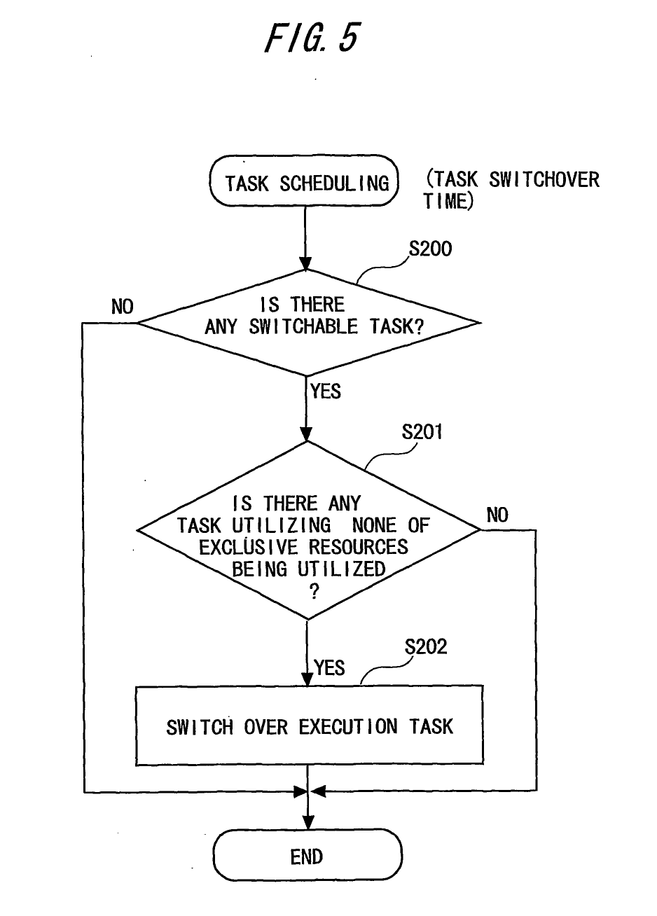

Next, processes when switching over the task will be explained. FIG. 5 is an explanatory flowchart of the processes when switching over the task.

The operating system 142, etc., is read and executed by the information processing device 100, thereby actualizing the following processes. Among the tasks 141 registered as the execution target tasks in the task information table 143, the task 141 having the shorter deadline time 143d is preferentially executed (which corresponds to an execution unit according to the present invention). Then, when reaching a switchover timing based on the task scheduling (which corresponds to a task switchover timing according to the present invention), it is judged whether or not there exists the task 141 possible of being switched over (S200). For example, it is judged whether or not the task 141 having the higher priority is registered in the task information table 143. When judging that the there are none of the tasks 141 possible of being switched over (S200: No), the following processes are not executed. While on the other hand, when judging that there exists the task 141 possible of being switched over (S200: Yes), it is judged whether or not there is a different task 141 that does not utilize the exclusive resource 130 in the midst of being utilized by the task 141 under the execution at the present (S201). This judgment is made based on the resource identifiers 143e in the task information table 143. Then, if there exists the task 141 assuming no such exclusive relationship (S201: Yes), the execution task is switched over (S202). Whereas if there are none of such tasks 141 (S201: No), the execution task is not switched over. Namely, if there is the task in the exclusive relationship (S201: No), the execution task is not switched over. The processes in S200 through S202 are redone each time the switchover timing based on the task scheduling is reached. With this scheme, when switching over the task, among the tasks 141 registered as the execution target tasks in the task information table 143, till the resource assignment to the task 141 having accessed earlier the exclusive resource 130 (corresponding to the specified resource according to the present invention) is completed, the assignment to the task 141 trying to access this exclusive resource afterward is delayed (or halted) (S201: No). This function corresponds to a control unit according to the present invention. Besides, even when delayed in this manner, it follows that the deadline time of the resource assignment to each of the tasks 141 is to be assured through the judgments (S102 and S103) about the task registrability described above.

As discussed above, according to the task management system in the present embodiment, when registering the task, the reservation judgment of the task 141 is performed (see FIG. 2, etc.) in such a form that the delay under the exclusive control is previously taken into consideration. When switching over the task, even if the access conflict occurs, the assignment to the task trying to utilize the resource by accessing afterward is delayed till the resource assignment to the task 141 having accessed earlier is completed.

Accordingly, even if the access conflict occurs, the resource assignment (the execution assignment time 143c) to the task 141 having accessed earlier is assured. In addition, the reservation judgment of the task 141 takes the delay caused by the access conflict into account (see FIG. 2), and hence the deadline time 143d of the resource assignment to each of the tasks 141 is also assured.

The present invention can be embodied in a variety of forms without deviating from the sprit or the principal features of the invention. The embodiment discussed above is nothing but a mere exemplification in every aspect. The present invention should not be limitedly construed by descriptions of those embodiments.

### INDUSTRIAL APPLICABILITY

According to the present invention, the setting of the accessibility to the resource requiring the exclusive control is effected when registering the task. The registrability of the task is judged in consideration of the delay under the exclusive control. When the access conflict occurs, the assignment to the task encountering the occurrence of the access conflict is halted till the assignment to the task in the midst of accessing is completed, thereby enabling the assurances of the validity of the process utilizing the resource requiring the exclusive control and of the deadline.

1. A task management system comprising:
a judgment unit judging whether or not an execution of a registration target task gaining an access to a specified resource can be completed before an elapse of deadline time thereof even if an execution start timing of the registration target task is delayed when registering the task;
a registration unit registering, as an execution target task, the registration target task judged such that the execution thereof can be completed before the elapse of the deadline time; and
a control unit halting a resource assignment to a task trying to access the specified resource afterward till a resource assignment to a task having earlier accessed to the specified resource is completed among the tasks registered as the execution target tasks when switching over the task.

2. A task management system comprising:
a judgment unit judging whether or not an execution of a registration target task gaining an access to a specified resource can be completed before an elapse of deadline time thereof even if an execution start timing of the registration target task is delayed when registering the task;
registration unit registering, as an execution target task, the registration target task judged such that the execution thereof can be completed before the elapse of the deadline time;
an execution unit preferentially executing a task having a shorter period of deadline time among the tasks registered as the execution target tasks; and
a control unit halting a resource assignment to a task trying to access the specified resource afterward till a resource assignment to a task having earlier accessed to the specified resource is completed among the tasks registered as the execution target tasks when switching over the task.

3. A task management method comprising:
a step of judging whether or not an execution of a registration target task gaining an access to a specified resource can be completed before an elapse of deadline time thereof even if an execution start timing of the registration target task is delayed when registering the task;
a step of registering, as an execution target task, the registration target task judged such that the execution thereof can be completed before the elapse of the deadline time; and
a step of halting a resource assignment to a task trying to access the specified resource afterward till a resource assignment to a task having earlier accessed to the specified resource is completed among the tasks registered as the execution target tasks when switching over the task.

4. A task management method comprising:
a step of judging whether or not an execution of a registration target task gaining an access to a specified resource can be completed before an elapse of deadline time thereof even if an execution start timing of the registration target task is delayed when registering the task;
a step of for registering, as an execution target task, the registration target task judged such that the execution thereof can be completed before the elapse of the deadline time;
a step of preferentially executing a task having a shorter period of deadline time among the tasks registered as the execution target tasks; and
a step of halting a resource assignment to a task trying to access the specified resource afterward till a resource assignment to a task having earlier accessed to the specified resource is completed among the tasks registered as the execution target tasks when switching over the task.
